(19) United States
(12) Patent Application Publication
(10) Pub. No.: US 2007/0054705 A1
(43) Pub. Date: Mar. 8, 2007

(54) Wireless apparatus with multiple power and input sources

(75) Inventors: Joseph Yuen Khim Liow, Singapore (SG); Bernard Lim, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 11/221,326

(22) Filed: Sep. 6, 2005

(51) Int. Cl. H04B 1/38; H04M 1/00

(52) U.S. Cl. 455/572

(57) ABSTRACT

There is provided a wireless apparatus for providing sound signals directly to at least one ear of a user, including: at least one power source to power the apparatus; at least one earphone; at least one receiver coupled to the at least one earphone; and at least one antennae connected to the at least one receiver. Preferably, the at least one power source is selected from capacitors, batteries, solar powered cells, or power from an electronic device through a wired connection. The apparatus may have an optical cable connectable to the electronic device. A method for powering the wireless apparatus is also disclosed.

### FIELD OF INVENTION

This invention relates to a wireless apparatus with multiple power and input sources and refers particularly, though not exclusively, to a wireless headset that is able to receive input and power from various sources and a method to power the wireless headset using multiple power sources.

### BACKGROUND

Wireless headsets are now commonplace, especially when used with mobile phones and with home entertainment systems. The wireless headsets may operate using a protocol such as, for example, Bluetooth, UWB, RF or IR. A user wearing the wireless headsets enjoys freedom of movement while using the wireless headsets. The use of wireless headphones may be advantageous not only for portability, but also to prevent others in a neighbouring room or area from being disturbed by the home entertainment system.

However, many of the wireless headsets use batteries that are not easily replaceable and require re-charging when drained. The user of such headsets are thus unable to continue using the headsets once the batteries are drained. Such circumstances cause inconveniences to the user, and the incidence of such circumstances would only increase as the usable time of the battery decreases due to repeated re-charging cycles.

In addition, wireless headsets nowadays are unable to offer enhanced sound quality like that of sound signals transmitted within optical cables because of the limitations of existing wireless transmission protocols. As such, users have to get separate wired headsets with optical cables to be able to enjoy the magnetic interference-free sound offered by headsets with optical cables.

### SUMMARY

There is provided a wireless apparatus for providing sound signals directly to at least one ear of a user, including: at least one power source to power the apparatus; at least one earphone; at least one receiver coupled to the at least one earphone; and at least one antennae connected to the at least one receiver. Preferably, the at least one power source is selected from capacitors, batteries, solar powered cells, or power from an electronic device through a wired connection. It is preferable that the wired connection is made using a connector such as, for example, a USB connector or earphone jack. The apparatus may also include an optical cable connectable to the electronic device.

Advantageously, the at least one receiver may be able to receive signals selected from the group of transmission protocols such as Bluetooth, UWB, RF or IR; and the electronic device may be a digital media player, a high fidelity system or a gaming console.

There is also provided a method for powering a wireless apparatus for providing sound signals directly to at least one ear of a user. The user uses the apparatus until an incorporated power source is drained to a predetermined level; and subsequently, the apparatus may be connected to an electronic device through a wired connection to continue operating by drawing power from the electronic device. It is preferable that the incorporated power source is at least one battery, at least one solar powered cell or at least one capacitor. A combination of the aforementioned power sources may also be incorporated into the apparatus.

Preferably, the electronic device may be selected from the group comprising: a digital media player, a high fidelity system and a gaming console. It is advantageous that the predetermined level of power may be indicated by either the lighting up of an LED incorporated in the apparatus or the generation of an audible sound directly to the ear of the user. It is preferable that the wireless apparatus is able to receive signals selected from the group of transmission protocols comprising: Bluetooth, UWB, RF and IR.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows a preferred embodiment of the present invention.

FIG. 2 shows a schematic diagram for a preferred embodiment of the present invention.

### DESCRIPTION OF PREFERRED EMBODIMENTS

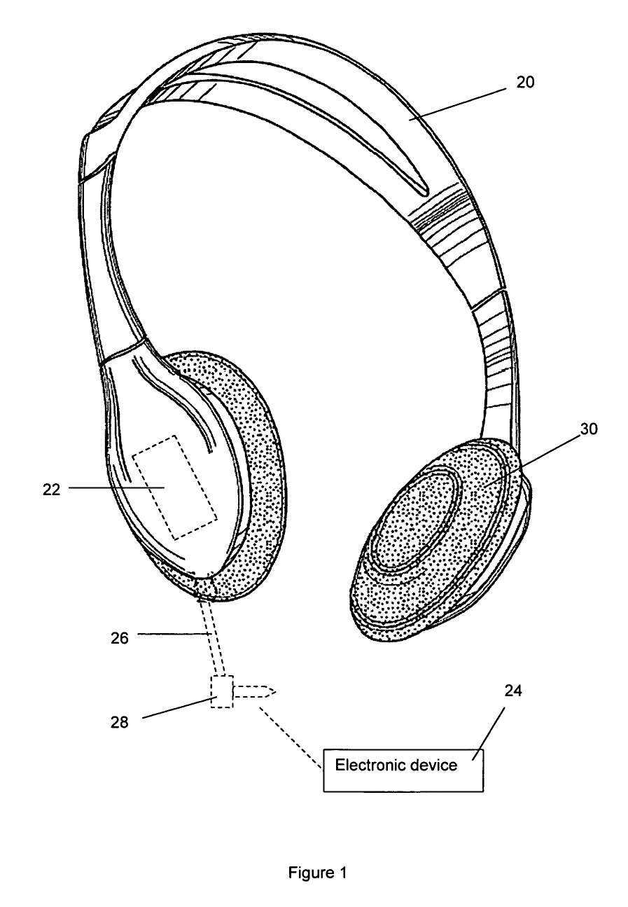

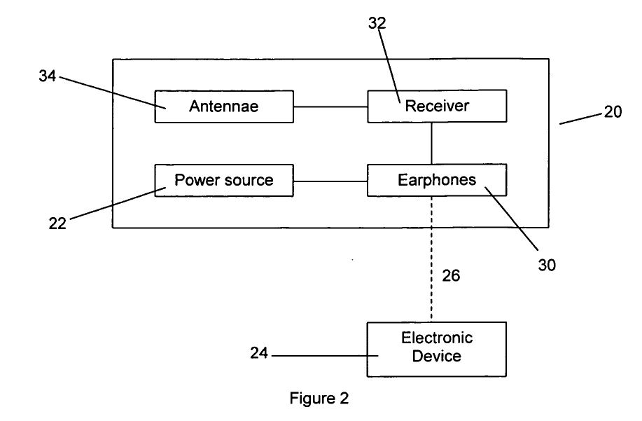

Referring to FIG. 1, there is shown a preferred embodiment of the present invention. FIG. 2 is a schematic diagram of a preferred embodiment of the present invention and will be referred to as well. There is shown a wireless apparatus 20 for providing sound signals directly to at least one ear of a user. The wireless apparatus 20 includes at least one power source 22 to power the apparatus 20. The at least one power source 22 may be capacitors, batteries, and/or solar powered cells. An alternative power source 24 may be an electronic device connected through a wired connection 26. The wired connection 26 may be enabled with either a USB connector or a earphone jack 28. There may also be multiple jacks 28 that separate from a single wired connection 26 or the wired connection 26 may comprise a plurality of cables with jacks 28 that are bundled together. Current to power the apparatus 20 may then be transferred subsequent to connection of wired connection 26.

The electronic device 24 may be a digital media player, a gaming console, a high fidelity system or any device which has a receptor/port that is able to receive either a USB connector or a earphone jack 28. The electronic device 24 may have an optical input such that versions of the wireless apparatus 20 with optical cables are also usable with the electronic device 24. A user of the wireless apparatus 20 may intentionally utilise optical cables with the apparatus 20 to enjoy improved sound quality.

The apparatus 20 may include at least one earphone 30, at least one receiver 32 coupled to the at least one earphone 30; and at least one antennae 34 connected to the at least one receiver 32. The antennae 34 and the receiver 32 may be incorporated into the apparatus 20 such that their presence is not discernible to a user. The at least one receiver 32 may be able to receive signals such as, for example, Bluetooth, UWB, RF and IR.

Since the apparatus 20 is wireless, it is powered by power source 22 when in use. However, when power source 22 is exhausted, apparatus 20 may still continue to function, albeit not in a wireless capacity, by direct connection to an electronic device using the wired connection 26. Current is drawn to apparatus 20 from the electronic device.

In a preferred embodiment of the present invention, there is provided a method for powering a wireless apparatus 20 for providing sound signals directly to at least one ear of a user. The method includes using the apparatus 20 until an incorporated power source 22 is drained to a predetermined level. Subsequently, the apparatus 20 is connected to an electronic device through a wired connection 26 to enable the apparatus 20 to continue operating by drawing power from the electronic device which acts as an alternative power source 24. The incorporated power source 22 may be capacitors, batteries, and/or solar powered cells. In the preferred embodiment of the method, the electronic device may be, for example, a digital media player, a gaming console, a high fidelity system or any device which has a receptor/port that is able to receive either a USB connector or a earphone jack 28. The wireless apparatus may be able to receive signals of wireless transmission protocols such as, for example, Bluetooth, UWB, RF and IR. As mentioned earlier, the predetermined level of power may be indicated to the user by ways such as, for example, the lighting up of an LED incorporated in the apparatus 20, and the generation of an audible sound in the earphones 30 that directly transmits the sound to the ear of the user.

In another embodiment of the present invention, there is provided another method for powering a wireless apparatus 20 with an incorporated solar-celled power source for providing sound signals directly to at least one ear of a user. This method includes using the apparatus until the incorporated solar-celled power source is drained to a predetermined level especially in the absence of sunlight and continuing the use of the apparatus with another (secondary) incorporated power source 22 until the incorporated power source 22 is drained to a predetermined level. Subsequently, connecting the apparatus 20 to an electronic device through a wired connection 26 would facilitate the continued operation of the apparatus 20 by drawing current from the electronic device which acts as an alternative power source 24. Besides the solar-celled power source, the other (secondary) incorporated power source may be at least one battery or at least one capacitor. In the preferred embodiment of the method, the electronic device may be, for example, a digital media player, a gaming console, a high fidelity system or any device which has a receptor/port that is able to receive either a USB connector or a earphone jack 28. The wireless apparatus may be able to receive signals of wireless transmission protocols such as, for example, Bluetooth, UWB, RF and IR. The predetermined level of power of the secondary power source 22 may be indicated to the user by ways such as, for example, the lighting up of an LED incorporated in the apparatus 20, and the generation of an audible sound in the earphones 30 that directly transmits the sound to the ear of the user.

Whilst there has been described in the foregoing description preferred embodiments of the present invention, it will be understood by those skilled in the technology concerned that many variations or modifications in details of design or construction may be made without departing from the present invention.

1. A wireless apparatus for providing sound signals to at least one ear of a user, including:
a first power source to power the apparatus, the first power source being selected from the group consisting of capacitors, batteries and solar powered cells;
at least one earphone;
at least one receiver coupled to the at least one earphone;
at least one antenna coupled to the at least one receiver; and
a wired connection for receiving power from an external device so as to enable continued use of the apparatus when the first power source is depleted.

2. The wireless apparatus as claimed in claim 1, wherein the connection includes a USB connector or an earphone jack.

3. The wireless apparatus as claimed in claim 1, wherein the at least one receiver is able to receive signals selected from the group of transmission protocols consisting of: Bluetooth, UWB, RF and IR.

4. The wireless apparatus as claimed in claim 1, wherein the external device is selected from the group consisting of: a digital media player, a high fidelity system and a gaming console.

5. The wireless apparatus as claimed in claim 1, further including an optical cable connectable to the external device.

6. A method for powering a wireless apparatus for providing sound signals directly to at least one ear of a user including: using the apparatus until an incorporated power source is drained to a predetermined level; and connecting the apparatus to an electronic device through a wired connection to continue operating the apparatus by drawing power from the electronic device.

7. The method as claimed in claim 6, wherein the incorporated power source is selected from the group comprising: at least one battery and at least one capacitor.

8. The method as claimed in claim 6, wherein the electronic device is selected from the group comprising: a digital media player, a high fidelity system and a gaming console.

9. The method as claimed in claim 6, wherein the predetermined level of power will be indicated by the ways selected from the group comprising: the lighting up of an LED and the generation of an audible sound directly to the ear of the user.

10. The method as claimed in claim 6, wherein the wireless apparatus is able to receive signals selected from the group of transmission protocols comprising: Bluetooth, UWB, RF and IR.

11. A method for powering a wireless apparatus for providing sound signals directly to at least one ear of a user including: using the apparatus until an incorporated solar-celled power source is drained to a predetermined level; continuing the use of the apparatus with a secondary incorporated power source until the incorporated power source is drained to a predetermined level; and connecting the apparatus to an electronic device through a wired connection to continue operating the apparatus by drawing current from the electronic device.

12. The method as claimed in claim 11, wherein the secondary incorporated power source is selected from the group comprising: at least one battery and at least one capacitor.

13. The method as claimed in claim 11, wherein the electronic device is selected from the group comprising: a digital media player, a high fidelity system, and a gaming console.

14. The method as claimed in claim 11, wherein the predetermined level of power will be indicated by the ways selected from the group comprising: the lighting up of an LED and the generation of an audible sound directly to the ear of the user.

15. The method as claimed in claim 11, wherein the wireless apparatus is able to receive signals selected from the group of transmission protocols comprising: Bluetooth, UWB, RF and IR.
